(19) United States
(12) Patent Application Publication
(10) Pub. No.: US 2004/0245773 A1
(43) Pub. Date: Dec. 9, 2004

(54) Plug-in connection device, especially for fluid lines

(76) Inventor: Axel Schneider, Sinzheim (DE)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/485,042

(22) PCT Filed: Jul. 22, 2002
(86) PCT No.: PCT/EP02/08126

(30) Foreign Application Priority Data
Jul. 26, 2001 (DE) 101 36 339.7

(51) Int. Cl. F16L 17/00

(52) U.S. Cl. 285/205; 285/368

(57) ABSTRACT

A plug connection device (1), in particular for securing and tightening fluid couplings (11), has a holding device with a holder (14), a plug-in element (26) and an extension spring element in the form of an annular extension spring (23). The annular extension spring (23) acts as a wedge between an annular surface (32) formed on the plug-in element (26) and an annular rim (19) formed on the holder (14). The annular extension spring (23) can perform a rolling movement around its chord center axis (24). A particularly low static friction is present here because of the support of the annular extension spring (23) on the annular rim (19), which permits a continuous automatic re-tightening of the holding device (12).

The invention relates to a plug connection device intended for connecting parts. A preferred field for the employment of the plug connection device is the connection of fluid conductors.

A plug connection device for pipes is known from U.S. Pat. No. 4,055,359, which employs an annularly closed extension spring as the snap-in element. The two parts of these plug connection devices which are to be connected with each other are pipe ends, which are pushed into each other. The outer pipe end has a rim which is angled off at approximately 45° in a funnel shape, whose conical outer face is used as a contact face for an annular spring. The inside located pipe end is provided with a flange, whose outer rim is bent inward in order to define an annular interior. The inward bent rim is embodied to be conical. Its inner face is located parallel opposite the conical outer face of the outwardly bent rim of the other pipe end at a distance. The annular spring is placed between both conical faces and in this way constitutes a blocking member preventing the inner pipe end from being pulled out of the outer pipe end, or the outer pipe end being pulled off the inner pipe end. In its blocking position, the annular spring rests against the outer face of the outside located pipe end. No axial bracing of the pipe ends against each other takes place.

A number of cases of use is known, wherein parts not only are to be connected, but also to be braced against each other in one direction. This is used, for example, for achieving a clatter-free connection, or for designing the connection to be tolerant in connection with manufacturing tolerances as well as soiling. On the other hand, in some cases of use it is intended to make the connection in the simplest possible manner, for example in that the parts to be connected are only placed against each other. It is possible by means of this to achieve a considerable simplification in manufacturing, for example in comparison with screwed connections.

Based upon this, the object of the invention is to provide a connection device which permits the making of the connection between two parts in a simple manner and which braces the parts against each other in one direction.

This object is attained by means of the plug connection device in accordance with claim 1. The plug connection device is particularly suited for securing two coupling elements of a fluid connector device with each other. The plug connection device has a holding device which is used to maintain the elements in the connected state. Parts of the holding device are a holding element, a plug-in element and a bracing element.

The plug-in element is to be inserted into a plug-in opening of the holding element. The holding element has an annular rim, opposite of which an annular face of the plug-in element is located. In the joined state, the bracing element is seated between the annular rim and the annular face and is therefore supported against the annular rim and the annular face.

Supporting the plug-in element on the holding element only on a rim has the advantage that possibly occurring static friction is substantially less here than with a more planar engagement. Thus, the bracing element can enter into its bracing seat not only during manufacture, i.e. making the connection, and brace the holding element and the plug-in element against each other, but further than that it can re-brace the connection which, per se, is at rest. If the bracing between the elements is diminished, the bracing element can move for again bracing the elements against each other. Inter alia, this occurs because of the reduced static friction on account of the bracing element only resting against a rim.

The bracing element is a slit annular ring, for example, or some other annular element. However, it is preferably designed as a closed ring, which can be resiliently widened. This has the advantage that the annular rim and the annular face are evenly stressed in all places, and that the formed snap-in device is substantially evenly effective at all locations on its circumference.

The bracing element preferably is an extension spring element, for example in the form of an annular extension spring. This has the substantial advantage that it can perform a rolling movement around its center axis extending in the circumferential direction. This center axis is also called a chord center axis. The embodiment of the extension spring element as a closed extension spring has several advantages, in particular in connection with the embodiment in accordance with the invention of the holding element and the plug-in element. The widening of the extension spring in the course of joining the plug connection can take place in that the spring element is rollingly widened over a conical area of the plug-in element. The rolling movement is relatively smooth running because of the low friction connected with it. Thus, short and steep cone areas and/or relatively strong extension springs can be used. The substantial advantage of an annular extension spring as the bracing element is shown, however, in the snapped-in state. In the course of this, one of the flanks of the extension spring is supported on the annular face, and the other flank on the annular rim. If now the connection between the elements is loosened because of the removal of a coating of dirt enclosed between the elements, the extension spring has a tendency to close up under its inherent tension and to brace the connection between the elements again. However, in the course of this it is first necessary to overcome the static friction holding it in its place. Since, different from sliding friction, the static friction is proportional to the contact face, the static friction at the annular rim is overcome practically immediately, while the static friction at the annular face remains. The extension spring can now close up by performing a rolling movement or revolving movement on the annular face and sliding on the annular rim. In the course of this the connection between the elements is re-braced with almost no hindrance. Re-bracing is possible in particular because the distance between the annular face and the annular rim becomes less with the diminishing diameter of the annular face. A narrowing bow-shaped area is created by this, in which the annular spring is braced by contraction. To this end the bracing element has a thickness which is less than the greatest distance between the annular face and the annular rim. In case of an annular spring, the thickness of the bracing element is understood to be its chord diameter.

The angle of the annular face in relation to the center axis of the plug-in element is preferably changed as a function of the diameter. For example, the annular face can be composed of two or more conical face sections. Because of this the annular face as a whole can be made relatively wide, i.e. the area in which its distance from the annular rim diminishes can become long. It is possible by means of this to achieve a bracing stroke of the holding device which is relatively large.

The annular face is preferably embodied to be arched. In this way the annular spring can roll evenly over the annular face when the connection is being re-braced.

The annular rim is formed on an annular shoulder of the plug-in opening. The annular shoulder can be a part of an annular groove in which the bracing element is maintained. In this way the desired connection is already made when joining the plug-in element and the holding element. However, it is also possible to transfer the annular spring element or other bracing element into its bracing position by means of a separate actuating element.

In an advantageous embodiment, an indicator sleeve is seated in the plug-in opening and supports the bracing element on its jacket surface. In this case the bracing element is simultaneously seated in the annular groove and is maintained in it by the indicator sleeve. This embodiment has the advantage that the bracing element cannot fall out of the annular groove, or can become jammed because it is seated skewed when the plug connection is made. It is possible that holding elements are used which are very small, which would fall out of the plug-in opening in the released state. Moreover, very hard bracing elements can be used. Finally, the conical head of the plug-in element can be embodied to be very short. Moreover, the indicator sleeve shows the correct establishment of the snapped-in connection. If no correct snap-in exists, the indicator sleeve projects less far out of the plug-in opening. In this case the dimensions can be matched to each other in such a way that the indicator sleeve completely moves out of the plug-in opening if the connection has been correctly made.

In the application for securing fluid couplings in particular it has been shown to be advantageous to provide the plug-in element with a further annular shoulder in addition to the annular shoulder, which assures a loose snapping-in of the parts into each other before the actual desired connection has been achieved. This has a considerable safety function. If, for example, in the course of establishing a fluid connection the desired connection has not been achieved because the parts to be connected have not been sufficiently brought together, the additional snap-in stage constitutes a catch stage, which keeps the parts together when the system is exposed to fluid pressure. In connection with fluid system under very high pressure in particular, for example air conditioning systems with CO₂ as the coolant, but also in other cases, the system is thus prevented from involuntary explosively opening.

It is considered to be advantageous if an edge is formed on the plug-in element which lies on one plane with the top of the holding element. This edge can constitute a catch area for condensate being formed, and therefore a protection against corrosion of the bracing element or the other parts involved.

The plug connection device in accordance with the invention permits lateral play, so that the axial positioning of the elements in respect to each other can be determined by other means, for example the coupling elements. This has advantages regarding the sealing of the coupling elements against each other. Thus, possible sealing elements are evenly stressed in the radial direction.

Further details of advantageous embodiments of the invention ensue from the drawings, the description or the dependent claims.

Exemplary embodiments of the invention are illustrated in the drawings. Shown are in:

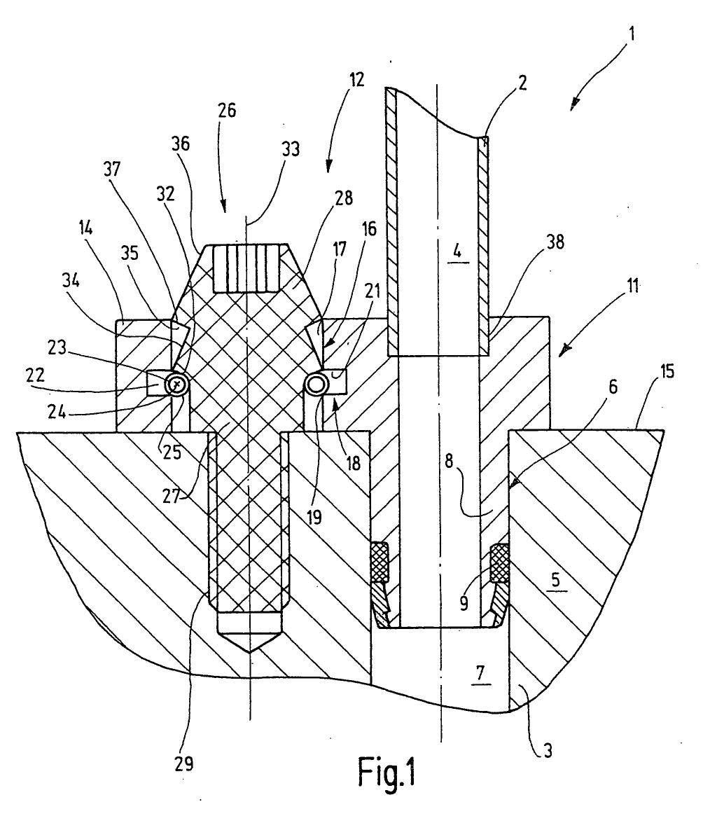

FIG. 1, an embodiment of the plug connection device in accordance with the invention in a basic representation in longitudinal section,

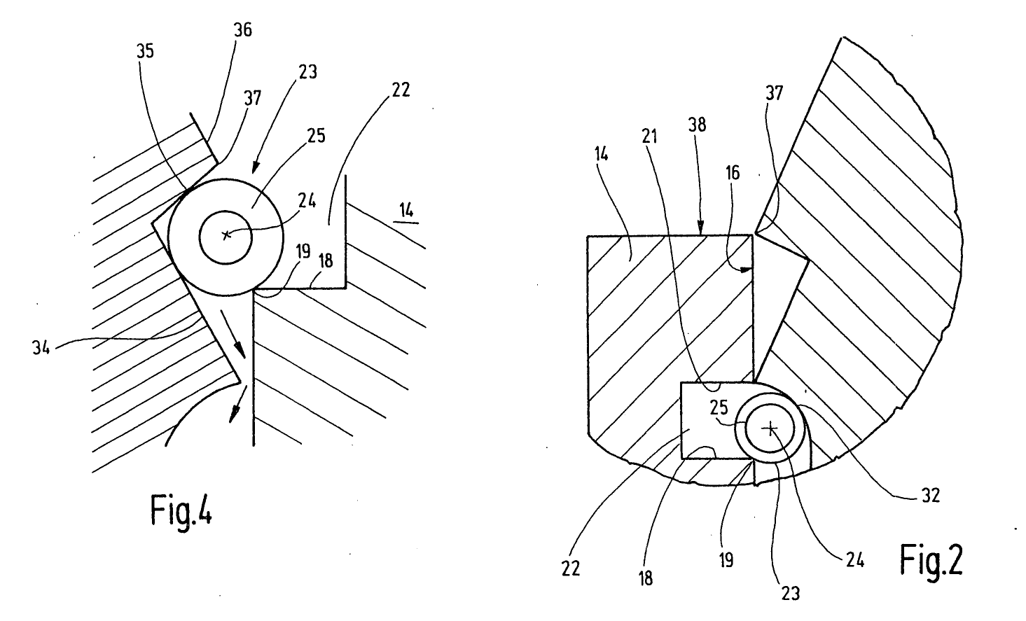

FIG. 2, the plug connection device in accordance with FIG. 1 in a partial representation in longitudinal section and on a different scale,

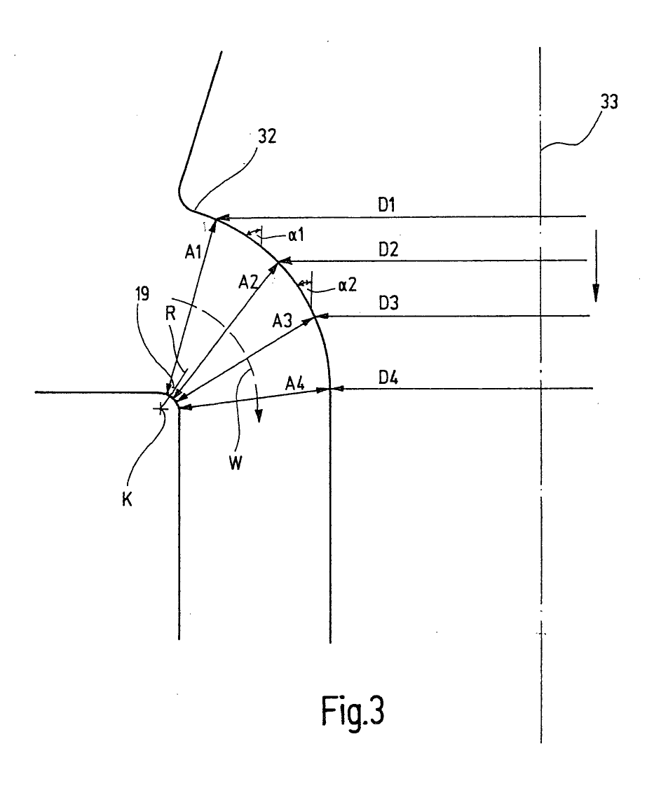

FIG. 3, the plug connection device in accordance with FIG. 2 in a basic representation for showing the geometry,

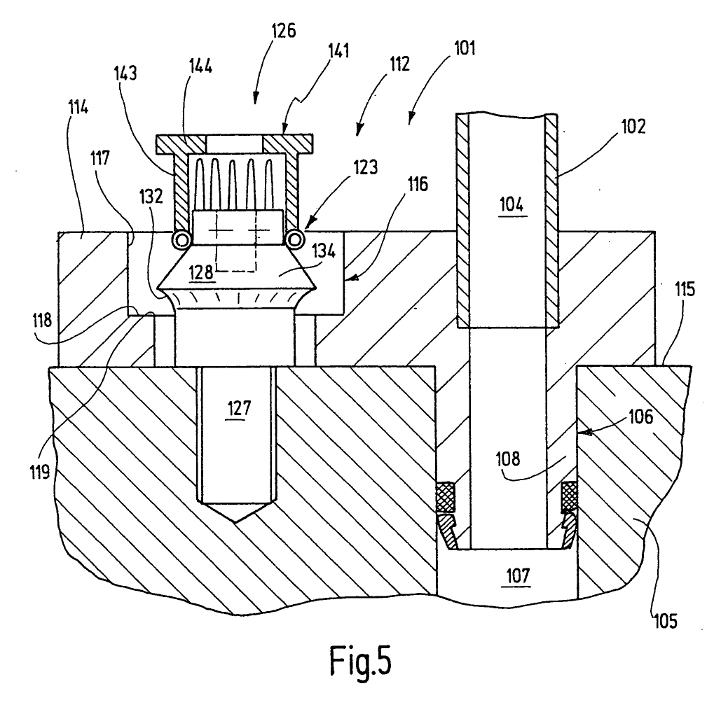

FIG. 4, the plug connection device in a partial representation in longitudinal section during the joining process,

FIGS. 5 to 7, a modified embodiment of the plug connection device in a representation in longitudinal section and in different states,

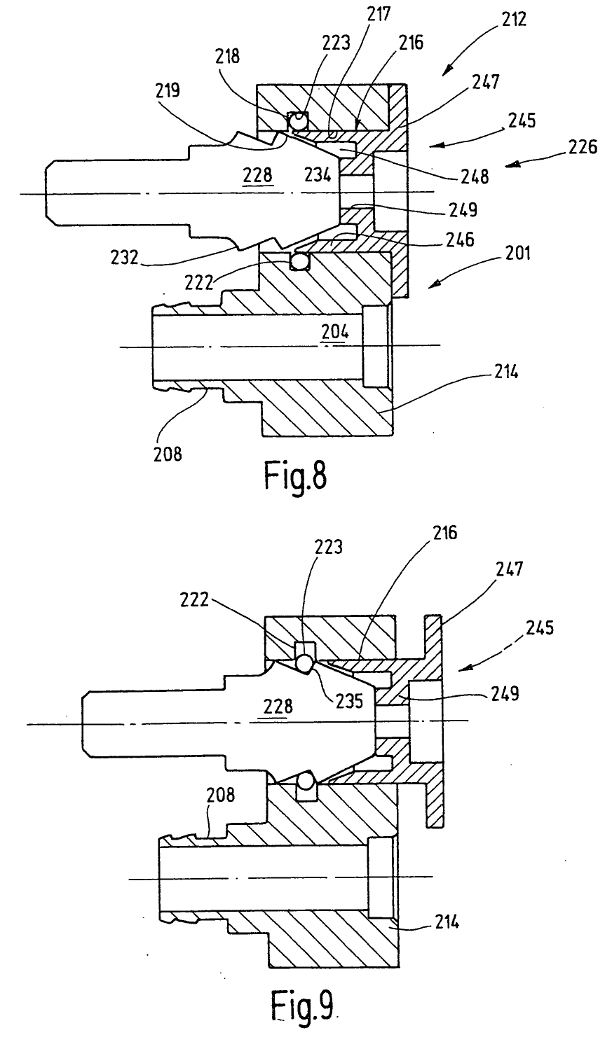

FIG. 8, a modified embodiment of the plug connection device in a representation in longitudinal section,

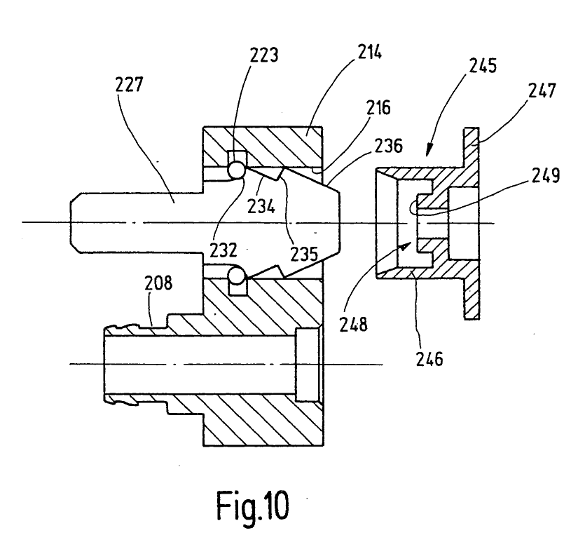

FIG. 9, the plug connection device in accordance with FIG. 8 in a first snap-in stage in a representation in longitudinal section, and

FIG. 10, the plug connection device in accordance with FIG. 8 in a representation in longitudinal section in the correctly connected state.

A plug connection device 1 used for connecting two fluid conductors 2, 3 is represented in FIG. 1. The fluid conductor 2, for example, is a tube or hose conductor which fixes a fluid conduit 4. The fluid conductor 3, for example, is a bore 6 formed in a housing 5 and forms a fluid conduit 7. The fluid conduit 4 leads into a pipe-like extension 9 constituting a first coupling element. It is introduced into the bore 6, so that the housing 5 constitutes a second coupling element. The extension 8 is provided with at least one sealing element 9, for example in the form of an O-ring, on its outer circumferential face for sealing the extension 8 against the wall of the opening 6, and therefore for sealing the fluid conduits 4, 7 toward the exterior.

A holding device 12 is provided for holding the fluid coupling 11 formed from the extension 8 and the housing 5 in which the bore 5 is fixed in the joined state. The holding device 12 has a holding element in the form of a holder 14 which in use rests flat against a flat surface 15 of the housing 5. As represented by way of example in the exemplary embodiment in accordance with FIG. 1, the holder 14 can extend laterally away from the fluid conduit 4. The holder 14 has a plug-in opening 16, which is a cylindrical passage, for example. The plug-in opening 16 has a wall 17, on which an annular step 18 with an annular rim 19 is formed. The step 18 faces away from the flat surface 15 against which the holder 14 is to be braced.

In the present embodiment a further, oppositely oriented step 21 is arranged above the step 18, so that between the steps 18, 21 an annular groove 22 is formed. The latter seats an annularly closed annular extension spring 23, which constitutes a bracing element. Like a common extension spring, the annular extension spring is made of a spring wire 25 wound helically around a chord center axis 25, wherein its ends are connected with each other. Thus, the annular extension spring 23 is embodied to be approximately in the shape of a torus.

A plug-in element 26 which, for example, is embodied as a bolt 27 with a profiled head 28, is furthermore a part of the holding device. This bolt 27 is screwed into a threaded bore 29 of the housing, for example. The head of the bolt 27 as a whole has a lesser diameter than the plug-in opening 16, so that the holder 14 can be pushed over the head 28 with its plug-in opening 16. On its circumferential face, the head 28 has an annular shoulder 31, which defines an annular face 32 on its lower side facing the step 21, and therefore the flat surface 15. The annular face 32 is located opposite the annular rim 19. The relationships can be seen in detail in FIG. 3. The annular face 32 is embodied to be arched. In longitudinal section it can be curved in the shape of an arc of a circle. However, a curvature has been shown to be advantageous which follows an elliptical arc. The annular rim 19 can also be embodied slightly rounded. The annular face 32 arranged coaxially in relation to an axis of symmetry 33 of the bolt 27 has a distance from the rim 19 which slowly decreases along the axis of symmetry 33. At a large diameter D1, a relatively large distance from the annular edge 19 exists, while at the smaller diameters D2, D3 and D4 an increasingly shorter distance A2, A3 and A4 from the annular rim 19 exists.

Thus, an annular space is formed between the annular rim 19 and the arched annular face 32, which continuously narrows along a curved path W. The path W has a constant radius R in respect to an axis of curvature K around which the annular rim 19 curves. The path W is the path which the annular extension spring 23, or its chord center axis, travels, at least in sections, while it braces the holder 14 against the bolt 27. The angle alpha of the annular face 32 in relation to the axis of symmetry 33 also decreases with decreasing diameter.

The annular face 32 constitutes a first snap-in stage, which is followed above it by a conical ramp section 34. The latter forms a relatively flat rising angle together with the axis of symmetry 33. It is used for widening the annular extension spring 23 in the course of joining the connection.

A second annular shoulder 35 is provided above the ramp section 34 and is adjoined by a further ramp section 36. An annular rim 37, whose diameter is only slightly less than the inner diameter of the plug-in opening and lies approximately at the same height as a flat outer face 38 of the holder 14, is formed between the ramp section 36 and the annular shoulder 35.

The plug connection device 1 so far described functions as follows:

For creating the plugged-in position represented in FIG. 1 of the plug connection device 1, first the extension 8 is introduced into the bore 6, and the plug-in opening 16 of the holder 14 is pushed over the head 28. In the process the ramp section 36 widens the relaxed annular spring 23, which is located in the annular groove 22 and protrudes into the plug-in opening 16. In the course of this the annular extension spring 23 rolls over the ramp section 36 and initially makes its way into a snap-in step over the annular rim 37. This state is represented in FIG. 4. Although the holder 14 is not yet firmly braced against the housing 5, it is secured to such an extent that the extension 8 can no longer be pushed out of the bore 6.

In the further plug-in process the holder 14 is further pushed on the head 28, so that now the ramp section 34 again widens the annular extension spring 23 which had contracted in the meantime. In the course of this the annular extension spring 23 again rolls on the jacket surface of the ramp section 34 until it has reached its end and jumps into the space between the annular face 32 and the annular rim 19. Here, the annular extension spring 23 is wedged into the existing space and in the process pushes the holder 14 against the housing 5.

If oil, dirt or the like exists on the flat surface 15, and if it disappears because of aging or vibration, the annular extension spring 23 can push the holder 14 further against the flat surface 15 in that the annular extension spring 23 further advances into the space between the annular face 32 and the annular rim 19 on its way W (FIG. 3). In the course of this the annular extension spring 23 can roll off on the annular face 32 by a rotation around its chord center axis 24 while gliding along the annular rim 19. The static friction between the annular rim 19 and the annular extension spring 23 is extremely small, so that the connection is easily re-braced.

If in the course -of making the connection the snap-in process should remain incomplete, and should the annular extension spring 23 really not have advanced into the space between the annular face 32 and the annular rim 19, the further annular shoulder 35 constitutes a safety catch zone. If the fluid conduits 4, 7 are pressurized without the snap-in having taken place securely, the extension 8 is moved for a short distance out of the bore 6. Therefore the holder 14 moves away from the housing 5 until the annular extension spring 23 comes into the position represented in FIG. 4, i.e. comes to rest against the annular shoulder 35. In this way the extension 8 cannot be further pushed out of the bore 6, and an uncontrolled opening of the fluid conduits is avoided.

In the joined state (FIG. 1), the annular rim 37 lies approximately at the height of the mouth of the plug-in opening 16 (FIG. 2). The distance between the annular rim 37 and the wall of the plug-in opening 16, or its upper edge, is very small and preferably lies in the range of a few tenths of a millimeter. Condensation collecting in this area, or moisture from the outside soon bridges this gap and is held there because of capillary action. In this way the advance of moisture into the area of the annular extension spring 23 is prevented. This represents an effective corrosion protection.

FIGS. 5 to 7 represent a modified embodiment. To the extent that structural and functional equivalence with the previously described plug connection device 1 exists, the same reference numerals, increased by the addend 100, are used, and reference is correspondingly made to the above description. In contrast to the above described plug connection device 1, the plug connection device 101 has a stepped plug-in opening 116, which does not contain an annular groove. Therefore the annular extension spring 123 is not held in an annular groove, instead it can move out of the plug-in opening 116. It is seated on a cylindrical extension 139 above the ramp section 134. To be able to move the annular extension spring 123 over the ramp section 134 and into the gap between the annular face 132 and the annular rim 119, an actuating element 141 is provided. This has a multiply slit cylindrical section 142, which is seated on the extension 139. Longitudinal slits release fingers 143 extending in axial direction, which are maintained on an end disk 144 and can spring radially outward.

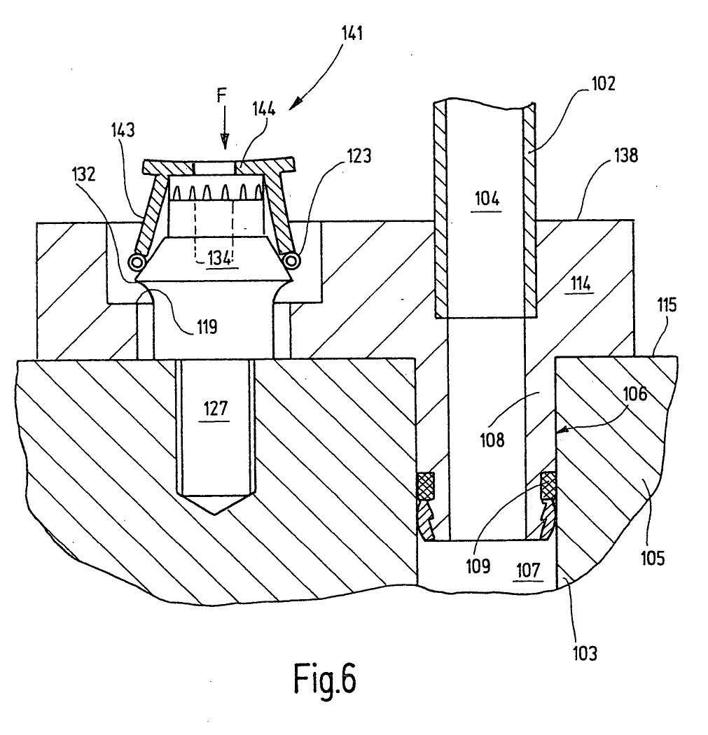

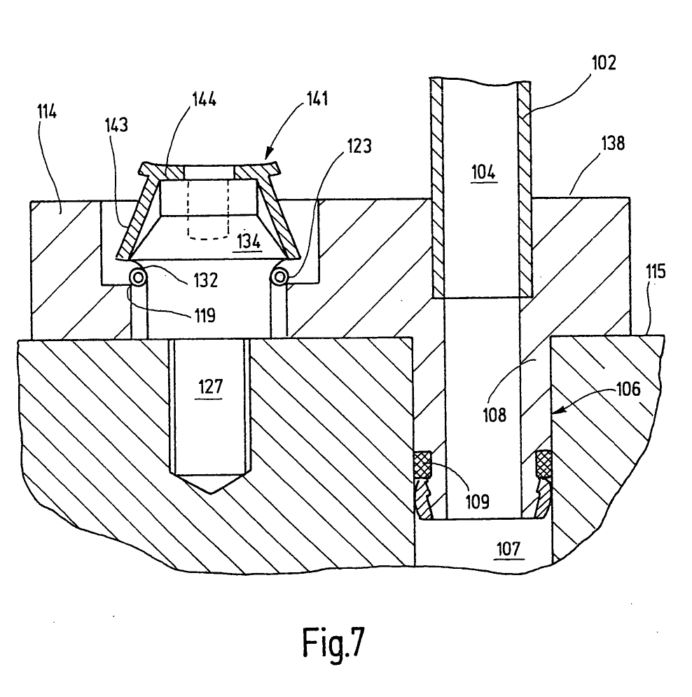

For making the connection, the holder 114 is pushed over the actuating element 141, and then over the head 128. As shown in FIG. 5, it thereafter first lies loosely on the flat surface 115. The actuating element 141 is now pushed down for making the connection by exerting a force K on the end disk 144. This is illustrated in FIG. 6. While the fingers 143 are spread open, the annular extension spring 123 is pushed over the ramp section 134 until its rolls past its end and reaches the space between the annular face 132 and the annular rim 119. Here the annular extension spring 123 braces the connection, as previously described in connection with the plug connection device 1. This state is illustrated in FIG. 7. If the fingers 143 are provided with a narrow snap-in groove on their inside, they can snap into the rim between the ramp section 134 and the annular face 132.

A further embodiment of the plug connection device 1 is illustrated in FIGS. 8, 9 and 10 in the form of a plug connection device 201. Reference is made to the description of the plug connection device 1 for describing the plug connection device 201. The description applies correspondingly. The reference numerals are increased by the addend 200.

In addition to the elements of the plug connection device 101 which can be seen in FIG. 1, an indicator sleeve 245 has been inserted into the plug-in opening 216 of the plug connection device 201. It has a dual function. Its first task consists in clearly indicating the establishment of the plug connection from the outside. Its second task consists in maintaining the annular extension spring 223 in its annular groove 222 as long as the head 228 is not yet seated in the plug-in opening 216. The indicator sleeve 245 has a hollow-cylindrical section 246 for this purpose, whose outer diameter approximately matches the inner diameter of the plug-in opening 216. A flange-like end disk 247 adjoins the section 246 and extends radially outward. The length of the cylindrical section 246 is of such a dimension, that the latter substantially covers the annular groove 222 when the end disk 247 rests against the holder 214. Thus the annular extension spring 223 rests against the jacket surface of the section 246 and is held by it in the annular groove 222.

The section 246 is embodied approximately tube-shaped and extends around a recess 248, into which the head 228 can slightly enter. The recess 248 is widened in a funnel shape on its outer end for this purpose. On its inside located end it has a bottom 249, whose position is fixed in such a way that the jacket surface of the ramp section 234 just stops short of touching the funnel-shaped end of the recess 248 when the head 228 rests against the bottom 249.

Functioning of the indicator sleeve 245 ensues from FIGS. 8 to 10. Prior to making the plug connection and at the start of the plug-in process (FIG. 8), the section 246 covers the annular groove 222 and keeps the annular extension spring 223 outside of the plug-in opening 216. For this reason annular extension spring elements 223 can be used, whose diameter in the relaxed state is small, so that they would project very far into the plug-in opening 216, or would fall out of it.

In the course of the further progress of the plug-in process, as illustrated in FIG. 9 the head 228 starts to push the indicator sleeve 245 out of the plug-in opening 216. Because of this the annular groove 222 is simultaneously released and the annular extension spring 223 finds its way behind the annular shoulder 235 (FIG. 9). With the further progress of the plug-in process, the indicator sleeve 245 is farther pushed out of the plug-in opening 216 by the front face of the head 228. Furthermore, the ramp section 234 again widens the annular extension spring 223 until the latter leaves the section 234 and finds its way behind the annular face 232.

In this state the holder 214 is tightened as described above in connection with the holder 14 and FIG. 1. The indicator sleeve 245 is furthermore pushed out of the plug-in opening 215 so that it falls off or can be easily removed. This indicates the correct establishment of the plug connection.

A plug connection device 1, in particular for securing and tightening fluid couplings 11, has a holding device with a holder 14, a plug-in element 26 and an extension spring element in the form of an annular extension spring 23. The annular extension spring 23 acts as a wedge between an annular face 32 formed on the plug-in element 26 and an annular rim 19 formed on the holder 14. The annular extension spring 23 can perform a rolling movement around its chord center axis 24. A particularly low static friction is present here because of the support of the annular extension spring 23 on the annular rim 19, which permits a continuous automatic re-tightening of the holding device 12.

1. A plug connection device (1, 101, 201), in particular for fluid conductors (2, 102, 202, 3, 103)
having a first part (8, 108, 208) and a second part (5, 105, 205), which are to be connected with each other,
having a holding device (12, 112, 212) used to hold the parts (5, 105, 8, 108, 208) together in the joined state in order to connect them, which comprises the following:
a holding element (14, 114, 214) connected with one of the parts (5, 105, 205, 8, 108, 208), which has a plug-in opening (16, 116, 216) with a wall (17, 117, 217), on which an annular step (18, 118, 218) with an annular rim (19, 119, 219) is formed,
a plug-in element (26, 126, 226) having an annular shoulder with an annular face (32, 132, 232), whose distance from the annular rim (19, 119, 219) becomes less with decreasing diameter, and
a bracing element (23, 123, 223), which is annularly embodied and, in the locked state, is arranged between the annular rim (19, 119, 219) and the annular face (32, 132, 232).

2. The plug connection device in accordance with claim 1, characterized in that-the bracing element (23, 123, 223) is embodied as a closed ring.

3. The plug connection device in accordance with claim 1, characterized in that the bracing element (23, 123, 223) is an extension spring element (23, 123, 223) having the shape of a torus with circular cross section.

4. The plug connection device in accordance with claim 1, characterized in that the extension spring element (23, 123, 223) is embodied to be flexible in such a way that it can perform a rolling movement around its chord center axis (24, 124, 224).

5. The plug connection device in accordance with claim 1, characterized in that the bracing element (23, 123, 223) is embodied as an annularly closed extension spring.

6. The plug connection device in accordance with claim 1, characterized in that the bracing element (23, 123, 223) has a thickness which is less than the greatest distance (A1) between the annular face (32, 132, 232) and the annular rim (19, 119, 219), and which is greater than the shortest distance (A4) between the annular face (32, 132, 232) and the annular rim (19, 119, 219).

7. The plug connection device in accordance with claim 1, characterized in that at a location of the least diameter (D4), the annular face (32, 132, 232) forms an angle (alpha 1) with the axis of symmetry (33, 133, 233) of the plug-in element (26, 125, 226), which differs from an angle (alpha 2) which is formed at another location (D1) with a greater diameter by the annular face (32, 132, 232) and the axis of symmetry (33, 133, 233).

8. The plug connection device in accordance with claim 1, characterized in that the annular face (32, 132, 232) is embodied to be arched.

9. The plug connection device in accordance with claim 1, characterized in that the holding element (14, 114, 214) in the wall of the plug-in opening (16, 116, 216) has an annular groove (22, 122, 222) adjoining the annular rim (19, 119, 219).

10. The plug connection device in accordance with claim 1, characterized in that the plug-in element (26, 226) has a cone-shaped or ramp section (34, 234) above its annular shoulder (31. 231).

11. The plug connection device in accordance with claim 1, characterized in that an indicator sleeve (245) is seated in the plug-in opening (216) of the holding element (214) and supports the bracing element (223) on its outer jacket surface.

12. The plug connection device in accordance with claim 1, characterized in that the indicator sleeve (246) is displaceably seated in the plug-in opening (216).

13. The plug connection device in accordance with claim 1, characterized in that the plug-in element (26, 226) has a further annular shoulder (35, 235) above its annular shoulder (31, 231).

14. The plug connection device in accordance with claim 1, characterized in that the plug-in element (26, 226) has a further cone-shaped or ramp section (36, 236) above its further annular shoulder (35, 235).

15. The plug connection device in accordance with claim 1, characterized in that an annular rim (37, 237) is provided on the plug-in element (26, 226) which, in the joined state of the holding device (12, 212), is located in a common plane with an outer face (38, 238) of the holding element (14, 214).

16. The plug connection device in accordance with claim 1, characterized in that the annular rim (37) is formed on the further annular shoulder (35).

17. The plug connection device in accordance with claim 1, characterized in that
the second part (5, 105) is a second coupling element (5, 105) having a receiving opening (6, 106) which is connected with a second fluid conduit (7, 107),
the first part (8, 108, 208) is a first coupling element (8, 108, 208) and forms an extension (8, 108, 208), which can be introduced into the receiving opening (6, 106) of an introduction device, at which a second fluid conduit (4, 104, 204) terminates,
at least one sealing element (9, 109) is provided, which is effective between the first coupling element (8, 108, 208) and the second coupling element (5, 105, 205) in order to seal the fluid conduits (4, 104, 204, 7, 107) toward the outside.

18. The plug connection device in accordance with claim 17, characterized in that the holding device (12, 112, 212) is arranged at a lateral distance to the first coupling element (8, 108, 208).

19. The plug connection device in accordance with claim 1, characterized in that the diameter of the head (28, 128, 218) is less than the diameter of the plug-in opening (16, 116, 216), so that in the snapped-in state the holding device 12, 112, 212) permits lateral movements.
